(19) United States
(12) Patent Application Publication
(10) Pub. No.: US 2023/0058520 A1
(43) Pub. Date: Feb. 23, 2023

(54) TRAFFIC FLOW FORECASTING METHOD BASED ON DEEP GRAPH GAUSSIAN PROCESSES

(71) Applicant: HUZHOU UNIVERSITY, Huzhou (CN)

(72) Inventors: Yunliang JIANG, Huzhou (CN); Xiongtao ZHANG, Huzhou (CN); Jungang LOU, Huzhou (CN); Jinbin FAN, Huzhou (CN); Danfeng SUN, Huzhou (CN); Ronghua LIANG, Huzhou (CN)

(73) Assignee: HUZHOU UNIVERSITY, Huzhou (CN)

(21) Appl. No.: 17/873,190

(22) Filed: Jul. 26, 2022

(30) Foreign Application Priority Data
Jul. 27, 2021 (CN) 202110849393.3

(51) Int. Cl. G06N 20/00; G06F 17/11; G06F 17/16; G08G 1/01

(52) U.S. Cl. CPC G06N 20/00; G06F 17/11; G06F 17/16; G08G 1/0125

(57) ABSTRACT

A traffic flow forecasting method based on Deep graph Gaussian processes includes: S1, with respect to the dynamics existing in a spatial dependency, using an attention kernel function to describe a dynamic dependency among vertices on a topological graph, and using the attention kernel function as a covariance function in an Aggregation Gaussian process to extract dynamic spatial features; S2, obtaining a Temporal convolutional Gaussian process from weights at different times and a convolution function that obeys the Gaussian processes, and obtaining temporal features in traffic data by combining the Aggregation Gaussian process; S3, constructing a Deep graph Gaussian process method integrating a Gaussian process and a depth structure from the Aggregation Gaussian process, the Temporal convolutional Gaussian process and a Gaussian process with a linear kernel function, inputting a data sample to be forecasted into the Deep graph Gaussian process method to obtain a forecasted result.

### CROSS REFERENCE TO THE RELATED APPLICATION

This application is based upon and claims priority to Chinese Patent Application No. 202110849393.3, filed on Jul. 27, 2021, the entire contents of which are incorporated herein by reference.

### TECHNICAL FIELD

The present application relates to the technical field of traffic flow forecasting, in particular to a traffic flow forecasting method based on Deep Graph Gaussian Processes.

### BACKGROUND

Traffic problems have become a common problem in cities all over the world, which seriously affects the operational efficiency and economic development of cities. As the main manifestation of urban traffic diseases, traffic congestion has a great impact on people's lives and work. Traffic congestion has caused great losses in economy, safety and environment, which has aroused widespread concern in the society. The research on the phenomenon and law of urban traffic congestion has become one of the hot spots in the traffic field. Based on this background, various forecasting methods of urban road traffic flow emerged.

In the prior art, a multi-feature spatiotemporal convolutional network model is proposed in areas with rich data resources to solve the problem of multi-data feature extraction and fusion, but providing rich data resources depends on a mature data platform. At present, it is still difficult to acquire, collect and manage data in economically backward areas, and the existing deep spatiotemporal model is unsatisfactory in learning from a small number of samples.

In view of a small amount of traffic flow data with special values in areas where data resources are scarce, in order to solve three problems: how to extract complex spatiotemporal features, how to quantify spatiotemporal uncertainty, and how to build a deep spatiotemporal model on a small number of samples, a traffic flow forecasting method based on Deep Graph Gaussian Processes is proposed.

### SUMMARY

The purpose of the present application is to solve the problems in the prior art by providing a traffic flow forecasting method based on Deep Graph Gaussian Processes, which can obtain complex features, predict traffic flow and quantify uncertainty with a small number of samples.

To achieve the above purpose, the present application provides a traffic flow forecasting method based on Deep Graph Gaussian Processes, which includes the following steps:

S1, with respect to the dynamics existing in a spatial dependency, using an attention kernel function to describe a dynamic dependency among vertices on a topological graph, and using the attention kernel function as a covariance function in an Aggregation Gaussian Process to extract dynamic spatial features;

S2, obtaining a Temporal Convolutional Gaussian Process from weights at different times and a convolution function that obeys the Gaussian processes, and obtaining temporal features in traffic data by combining the Aggregation Gaussian Process;

S3, constructing a Deep Graph Gaussian Process method integrating a Gaussian process and a depth structure from the Aggregation Gaussian Process, the Temporal Convolutional Gaussian Process and a Gaussian process with a linear kernel function, inputting a data sample to be forecasted into the Deep Graph Gaussian Process method, extracting the spatial dependency by the aggregation operation in step S1, then obtaining the spatiotemporal features by the convolution operation in step S2, and inputting the obtained spatiotemporal features into the Gaussian process with the linear kernel function to obtain a forecasted result.

Preferably, the step S1 specifically includes the following steps:

S11. using a kernel function K_{E}(⋅,⋅) to describe the dynamic correlation in space, and the relation between graph vertices being expressed as

W=(I+A)K_{E}(x, x′) (1)

where W represents a weight of each edge on the topological graph, K_{E}(x, x′) is used to measure the dynamic correlation between the vertices, and a identy matrix I is used to indicate the existence of a self-loop on the topological graph, so as to express the influence of the vertex feature of the current graph on itself at different times;

S12. based on equation (1), extracting the spatial features at a certain time in the following way

$${\hat{h}}_{i} = \frac{{W}_{ii} f ( {x}_{i} ) + {\sum }_{j ∈ Ne ( i )} {W}_{ij} f ( {x}_{j} )}{{D}_{ii}} \qquad ( 2 )$$

where a diagonal element in a diagonal matrix in equation (2) is Dᵢᵢ=Wᵢᵢ+Σ_{j∈Ne(i)}Wᵢⱼ, and Ne(i)={j:j∈{1, . . . , N}, Aᵢⱼ=1}represent the neighboring vertices of an i^{th} vertex on the topological graph at the moment;

S13. based on the Aggregation Gaussian Process shown in the equation (2), letting a vertex mapping function f(⋅) obey the Gaussian process with a mean function of m_{N}: R^{F}→R^{\hat{F}}and a covariance function of K_{N}: R^{F×F}→R^{\hat{F}}, that is, f (x)˜ [symbol] (m_{N}(x), K_{N}(x,x′)), abbreviated as f (x)˜ [symbol] (m_{N}, K_{N}); from the equation (2), the Aggregation Gaussian Process that can obtain the dynamic dependency between vertices can be obtained, that is, the following representation:

ĥ|x˜ [symbol] (Pm_{N}, PK_{N}P^{T}) (3)

where P=D⁻¹W and K_{N,ij}=K_{N}(xᵢ, x₁); accordingly, the spatial features Ĥ=[ĥ¹, ĥ², . . . , ĥ^{C}) ] ∈ R^{C×N×\hat{F}} at C monents can be expressed as a result after independent sampling at multiple times, and obey the probability distribution p(Ĥ|X)=Π_{c=1}^{C}p(ĥ^{c}).

Preferably, the covariance function in the Gaussian process selects a positive definite kernel function K_{N}(⋅,⋅), the covariance function is rewritten as an inner product form between feature maps, i.e., K_{N}(xᵢ, xⱼ)=ϕ(xᵢ)ϕ(xⱼ)^{T}, and K_{N}=Φ_{N}Φ_{N}^{T}; the Aggregation Gaussian Process represented by equation (3) contains an attention kernel function K_{A}=PΦ_{N}Φ_{N}^{T}P^{T}=Φ_{A}Φ_{A}^{T} that describes the structure of dynamic graph, where Φ_{A}=PΦ_{N}; the Aggregation Gaussian Process is expressed as ĥ˜ [symbol] (Pm_{N}, K_{A}) by using the attention kernel function.

Preferably, a variational form of the Aggregation Gaussian Process is realized as follows:

assuming that a set of supporting random variables û=[f(z₁), f(z₂), . . . , f(z_{M}_{_{f}})] obey a multidimensional Gaussian distribution with a mean of \hat{m} ∈ R^{M}^{_{f}}^{×\hat{f}} and a covariance of Ŝ ∈ R^{M}^{_{f}}^{×M}^{_{f}}; wherein, the assumed set of supporting points {zₘ}₌₁^{M}^{_{f}} and an input x of the Aggregation Gaussian Process belong to a same data distribution, there is no topological connection between the data points in the set of supporting points, that is , there is no connection between data points in the set of supporting points, and the data points in the set of supporting points and an input set; a calculation method for the correlation between the data points in the set of supporting point and the data points in the input set is K*_{N}=PK_{N}(x,Z), and a calculation method for the correlation within the set of supporting point is K**_{N}=K_{N}(z, z);

based on the above assumption, there is the following variational probability representation at C moments:

q(Û)=Π_{c=1}^{C} [symbol] (\hat{m}_{c}, Ŝ_{c} (4)

based on the set of supporting points and the variational probability distribution q(Û) of the above assumption, a variational joint distribution of the Aggregation Gaussian Process is expressed as follows:

q(Ĥ, Û|X, Z,)=p(Ĥ|X, Û, Z)q(Û) (5)

where Z is composed of a set of supporting points at C moments, and is assumed to belong to the same distribution as the input at each time; a support variable in the above equation is calculated by a Bayesian equation, and the variational distribution of the Aggregation Gaussian Process after the support variable is marginalized is obtained, q (Ĥ|H, Z) can be obtained by equation (5).

Preferably, the step S2 specifically includes the following steps:

S21. the temporal features including spatial features on the i^{th} vertex are acquired in the following way, namely

hᵢ=Σ_{c=1}^{C}w_{c}g(ĥᵢ^{c}) (6)

where the vertex information ĥᵢ of the graph at each moment is subjected to convolution operation first, and then the spatiotemporal feature hᵢ at the i^{th} vertex can be obtained from the connection at different moments;

S22. by operating the mapping function f(⋅), letting the convolution operation method g(⋅) obey the Gaussian process with a mean function of m_{C}: R^{\hat{F}}→R^{F′} and a covariance function of K_{C}: R^{\hat{F}×\hat{F}}→R^{F′}, that is, g(ĥ^{c})˜ [symbol] (m_{C}(ĥ^{c}), K_{C}(ĥ^{c}, ĥ^{c′})), abbreviated as [symbol] (m_{c}, K_{C}); the following Temporal Convolutional Gaussian Process with a weighted convolution kernel function can be obtained from equation (6),

hᵢ|ĥᵢ, w˜ [symbol] (Σ_{c=1}^{C}w_{c}m_{C}, Σ_{c=1}^{C}Σ_{c′=1}^{C}w_{c}w_{c′}K_{C}) (7) ;

S23. vectorizing the weight w_{c} so as to obtain w=[w₁, w₂, . . . , w_{C}] ∈ R^{C}; a matrix shape corresponding to ĥᵢ is adjusted to [ĥᵢ¹, ĥᵢ², . . . , ĥᵢ^{C}]^{T} ∈ R^{C×\hat{F}} with the C moments constant and a feature length \hat{F} unchanged at the i^{th} vertex, and the Temporal Convolutional Gaussian Process is simplified into the following form:

hᵢ|ĥᵢ, w˜ [symbol] (wm_{c}, w^{T}K_{C}w) (8)

where K_{C,cc′}=K_{C}(ĥᵢ^{c}, ĥᵢ^{c′}) represents the similarity between the feature at the c^{th} moment and the feature at the c′^{th} moment, and the spatiotemporal feature H=[ĥ₁, ĥ₂, . . . , ĥ_{N}] ∈ R^{1×N×F′} satisfies the following probability distribution form p(H|Ĥ)=Πᵢ₌₁^{N}p(hᵢ).

Preferably, the variational form of the Temporal Convolutional Gaussian Process is realized as follows:

the set of supporting points {\hat{z}_{m′}}_{m′=1}^{M}^{_{g}} with the same distributions as ĥ is introduced, and the set of supporting points is calculated by a convolution operation g(⋅) to obtain a supporting random variable

$$u = [ ℊ ( {\hat{z}}_{1} ) , ℊ ( {\hat{z}}_{2} ) , … , ℊ ( {\hat{z}}_{{M}_{ℊ}} ) ] ,$$

which is made to obey the multidimensional Gaussian distribution q(u) with a mean of m ∈ R^{M}^{_{g}}^{×F′} and a covariance of S ∈ R^{M}^{_{g}}^{×M}^{_{g}};

when calculating the variational joint distribution, the calculation of the covariance also needs to be combined with the temporal correlation, that is, K*_{C}=w^{T}K_{C}(ĥ, \hat{z}) and K**_{C}=K_{C}(\hat{z}, \hat{z}); based on this, the variational joint expression of the Temporal Convolutional Gaussian Process is constructed,

q(H, U|Ĥ, \hat{Z})=p(H|Ĥ, U, \hat{Z})q(U) (9)

where q(U)=Πᵢ₌₁^{N} [symbol] (m, S); after marginalizing the supporting variables in the above equation, the variational probability q(H|Ĥ, \hat{Z}) of the Temporal Convolutional Gaussian Process is obtained.

Preferably, the step S3 specifically includes the following steps:

S31. obtaining a unit for acquiring the spatiotemporal feature H ∈ R^{N×F×C} by stacking the Aggregation Gaussian Processes that can extract spatial dependency and the Temporal Convolutional Gaussian Processes that can extract temporal features, wherein the input of a first layer in the proposed Deep Graph Gaussian Process model is spatiotemporal data H⁰=X, and the transformation of an adjacency matrix A as an input into the weight matrix has been included in the Aggregation Gaussian Process; secondly, subjecting the spatiotemporal feature [symbol] as the input of [symbol] layer to an aggregation operation to extract spatial dependency, and then to a convolutional operation to obtain spatiotemporal features therein; finally, inputting H^{L} to a forecasted result obtained in the Gaussian process with a linear kernel function;

S32, letting the mapping function [symbol] (⋅) and temporal convolution function [symbol] (⋅) in each layer obey the Gaussian process respectively, wherein the Gaussian process that the mapping function [symbol] (⋅) obeys has a mean function of [symbol] : [symbol] → [symbol] and a covariance function of [symbol] : [symbol] → [symbol] , while the temporal convolution function [symbol] (⋅) obeys the Gaussian process with a mean function of [symbol] : [symbol] → [symbol] and a covariance function [symbol] : [symbol] → [symbol] ; the final output layer o(⋅) obeys the Gaussian process defined with a linear covariance function of Kₒ:R^{F}^{_{L}}^{×F}^{_{L}}→R^{F}^{₀} and a mean function of mₒ: R^{F}^{_{L}}→R^{F}^{ₒ}; based on the above probability expression, the joint distribution of the Deep Graph Gaussian process is as follows:

p(y, ŷ, { [symbol] , [symbol] )=Πᵢ₌₁^{N}p(yᵢ|ŷᵢ)p (ŷ|H^{L}) [symbol] p( [symbol] | [symbol] )p( [symbol] | [symbol] ) (10)

where ŷ ∈ R^{N}represents the forecasted result given by the method of Deep Graph Gaussian Processes.

Preferably, the variational form of the Deep Graph Gaussian Processes is realized as follows:

support variables [symbol] and [symbol] are introduced into the Aggregation Gaussian Process and Temporal Convolutional Gaussian Process respectively for each layer, and at the same time, it is assumed that the probability distributions thereof are respectively q( [symbol] )=Π_{c=1}^{c}^{_{l−1}} [symbol] ( [symbol] , [symbol] ) and q( [symbol] )=Πᵢ₌₁^{N} [symbol] ( [symbol] , [symbol] ); using the construction method of the set of supporting points in the Aggregation Gaussian Process, Z^{o} composed of the set of supporting points and supporting variable distribution q(U^{o})= [symbol] (mₒ, Sₒ) at an output layer are obtained; the variational joint form of the Deep Graph Gaussian processes can be as follows:

q(ŷ, U^{o}, { [symbol] , [symbol] , [symbol] , [symbol] )=p(ŷ|H^{L}, U^{o}, Z^{o})q(U^{o})· [symbol] p( [symbol] | [symbol] , [symbol] , [symbol] )q( [symbol] )p( [symbol] | [symbol] , [symbol] , [symbol] )q( [symbol] ) (11) ;

based on the above marginalization, the variational form of the Deep graph Gaussian Processes is expressed as follows

q(ŷ, { [symbol] , [symbol] )=q(ŷ|H^{L}, Z^{o})· [symbol] q( [symbol] | [symbol] , [symbol] )q( [symbol] | [symbol] , [symbol] ) (12)

Preferably, the learning method based on the variational form of the Deep graph Gaussian Processes is as follows:

after calculating a marginal probability for the variational distribution of H^{l} and Ĥ^{l} in equation (12), the posterior probability of the variational Deep Graph Gaussian Processes can be expressed as follows

$$q ( {\hat{y}}_{i} ) = {\int }_{{H}_{i}^{ℓ} , {\hat{H}}_{i}^{ℓ}} q ( {\hat{y}}_{i} , {\{ {H}_{i}^{ℓ} , {\hat{H}}_{i}^{ℓ} \}}_{ℓ = 1}^{L} ) \qquad ( 13 )$$

where, ŷᵢ is the forecasted result of the traffic flow on the i^{th} vertex with independent spatiotemporal features;

based on the derivation of the variational form of the Deep Graph Gaussian Processes and the variational posterior form thereof, an empirical minimum lower bound of the Deep Graph Gaussian Processes is as follows

$${ℒ}_{DGGPs} = {q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}_{} [ log ( \frac{p ( y , \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}{q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )} ) ] \qquad ( 14 )$$

in addition, from equation (10), equation (11) and equation (13), equation (14) can be obtained:

[symbol]

_{DGGPS}=Σᵢ₌₁^{N} [symbol] _{q(ŷ}_{ᵢ₎}[p(yᵢ|ŷᵢ)]−KL[q(U^{o})∥p(U^{o}|Z^{o})] [symbol] (KL[q( [symbol] )∥p( [symbol] | [symbol] )]+KL[q( [symbol] )∥p( [symbol] )|( [symbol] )]) (15)

The method has the beneficial effects that the problem that dynamic spatial dependency cannot be obtained is solved by the proposed method of an Aggregation Gaussian process. The complex spatiotemporal features are extracted by combining the Aggregation Gaussian Process and the Temporal Convolutional Gaussian Process. The proposed Deep Graph Gaussian Processes combines the advantages of a Gaussian process and a depth structure, so as to obtain complex features, predict traffic flow and quantify uncertainty with a small number of samples.

The features and advantages of the present application will be described in detail by examples with reference to the accompanying drawings.

### BRIEF DESCRIPTION OF THE DRAWINGS

FIGS. 1A-1C show schematic diagrams of the Deep Graph Gaussian Process method of the present application, in which FIG. 1A is a block diagram of the Deep Graph Gaussian Processes, FIG. 1B is a unit for extracting spatiotemporal features in FIG. 1A, and FIG. 1C is an output unit in FIG. 1A;

FIG. 2 is a schematic diagram of the Aggregation Gaussian Process in the present application;

FIG. 3 is a schematic diagram of the Temporal Convolutional Gaussian Process in the present application;

FIGS. 4A-4D show comparison diagrams of different aggregation modes;

FIGS. 5A-4D show a comparison between the actual traffic flow and the forecasted value on HHY;

FIGS. 6A-6B show the heat maps of the evaluation results on HHY;

FIGS. 7A-7D show the comparison between the actual traffic flow and the forecasted value on PeMS03;

FIGS. 8A-8B show the heat maps of the evaluation results on PeMS03;

FIGS. 9A-9D show the comparison between the actual traffic flow and the forecasted value on PeMS07;

FIGS. 10A-10B show the heat maps of the evaluation results on PeMS07.

### DETAILED DESCRIPTION OF THE EMBODIMENTS

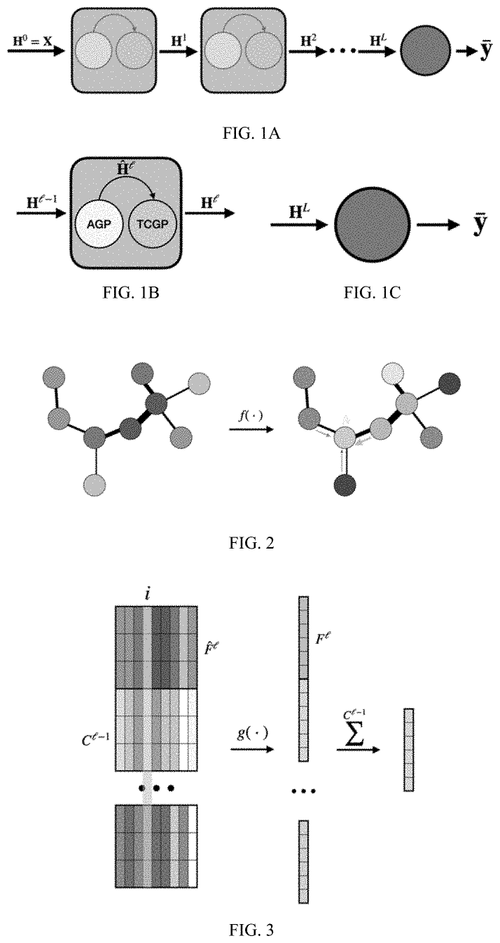

As shown in FIGS. 1A-1C, the Deep Graph Gaussian Process method proposed by the present application respectively adopts the first proposed Aggregation Gaussian Process (AGP), Temporal Convolutional Gaussian Process (TCGP) and Gaussian process with a linear kernel function. Specifically, the Aggregation Gaussian Process contains the attention kernel function which can describe the dynamic spatial dependency, so as to obtain the spatial features, especially the dynamic spatial features which cannot be extracted by the existing Gaussian process and its depth structure. Temporal Convolutional Gaussian Process is used to obtain the temporal features of traffic data. Another example is that a certain spatiotemporal feature extraction unit in FIG. 1B is composed of an Aggregation Gaussian Process and a Temporal Convolutional Gaussian Process. This combination method can better obtain complex spatiotemporal features. Among the proposed methods, the Gaussian process method with a linear kernel function takes the extracted complex spatiotemporal features as input, predicts traffic flow and quantifies spatiotemporal uncertainty. Because the proposed method is composed of a Gaussian process and a -deep structure, the Deep graph Gaussian Process can obtain the most representative features from a small amount of data, and give a forecasted value of the traffic flow and a quantitative result of spatiotemporal uncertainty.

1. Aggregation Gaussian Process and its variational form

S1. The steps to realize the Gaussian Aggregation Process are as follows:

S11. First of all, as shown in FIG. 2, there is an obvious dynamic correlation in the space of a traffic scenario, such as the traffic flows at adjacent vertices. In order to solve the problem that the existing Gaussian process and deep Gaussian process cannot obtain the dynamic dependency between graph vertices, a kernel function K_{E}(⋅,⋅) is adopted to describe the spatial dynamic correlation, and the relation between graph vertices is as follows:

W=(I+A)K_{E}(x, x′) (1)

where W represents a weight of each edge on the topological graph, K_{E}(x, x′) is used to measure the dynamic correlation between the vertices, and a identity matrix I is used to indicate the existence of a self-loop on the topological graph, so as to express the influence of the vertex feature of the current graph on itself at different times; in addition, A is an adjacency matrix of the vertices of the graph.

S12. Based on equation (1), the spatial features at a certain time are extracted in the following way

$${\hat{h}}_{i} = \frac{{W}_{ii} f ( {x}_{i} ) + {\sum }_{j ∈ Ne ( i )} {W}_{ij} f ( {x}_{j} )}{{D}_{ii}} \qquad ( 2 )$$

where a diagonal element in a diagonal matrix in equation (2) is Dᵢᵢ=Wᵢᵢ+Σ_{j∈Ne(i)}Wᵢⱼ, and Ne(i)={j:j ∈ {1, . . . , N}, Aᵢⱼᵢ=1} represent the neighboring vertices of an i^{th} vertex on the topological graph at the moment.

S13. Based on the Aggregation Gaussian Process shown in the equation (2), let a vertex mapping function f (⋅) obey the Gaussian process with a mean function of m_{N}: R^{F}→R^{\hat{F}} and a covariance function of K_{N}: R^{F×F}→R^{\hat{F}}, that is, f (x)˜ [symbol] (m_{N}(x), K_{N}(x,x′)), abbreviated as f (x)˜ [symbol] (m_{N}, K_{N}); from the equation (2), the Aggregation Gaussian Process that can obtain the dynamic dependency between vertices can be obtained, that is, the following representation:

ĥ|x˜ [symbol] (Pm_{N}, PK_{N}P^{T}) (3)

where P=D⁻¹W and K_{N,ij}=K_{N}(Xxᵢ, xⱼ); accordingly, the spatial features Ĥ=[ĥ¹, ĥ², . . . , ĥ^{C}] ∈ R^{C×N×\hat{F}} at C monents can be expressed as a result after independent sampling at multiple times, and obey the probability distribution p(Ĥ|X)=Π_{c=1}^{C}p(ĥ^{c}).

In addition, the covariance function in the Gaussian process selects a positive definite kernel function K_{N}(⋅,⋅), therefore the covariance function is rewritten as an inner product form between feature maps, i.e., K_{N}(xᵢ, xⱼ)=ϕ(xᵢ)ϕ(xⱼ)^{T}, that is, K_{N}=Φ_{N}Φ_{N}^{T}. Based on this, the process of obtaining dynamic dependencies between the vertices proposed for the first time in this text can be explained accurately by mathematics, that is, the Aggregation Gaussian Process represented by equation (3) contains an attention kernel function K_{A}=PΦ_{N}Φ_{N}^{T}P^{T}=Φ_{A}Φ_{A}^{T} that describes the structure of dynamic graph, where Φ_{A}=PΦ_{N}; therefore, the Aggregation Gaussian Process is expressed as ĥ˜ [symbol] (Pm_{N}, K_{A}) by using the attention kernel function.

In addition, in order to describe the learning process of the Deep Graph Gaussian Process conveniently, the variational form of the Aggregation Gaussian Process is introduced.

The variational form of the Aggregation Gaussian Process is realized as follows:

firstly, assuming that a set of supporting random variables û=[f(z₁), f(z₂), . . . , f(z_{M}_{_{f}})] obey a multidimensional Gaussian distribution with a mean of \hat{m} ∈ R^{M}^{_{f}}^{×\hat{F}} and a covariance of Ŝ ∈ R^{M}^{_{f}}^{×M}^{_{f}};

secondly, the assumed set of supporting points {zₘ}ₘ₌₁^{M}^{_{f}} and an input x of the Aggregation Gaussian Process belong to a same data distribution, but there is no topological connection between the data points in the set of supporting points, that is, there is no connection between data points in the set of supporting points, and the data points in the in the set of supporting points and an input set; therefore a calculation method for the correlation between the data points in the set of supporting point and the data points in the input set is K*_{N}=PK_{N}(x, z), and a calculation method for the correlation within the set of supporting point is K**_{N}=K_{N}(z, z).

Based on the above assumption, there is the following variational probability representation at C moments:

q(Û)=Π_{c=1}^{C} [symbol] (\hat{m}_{c}, Ŝ_{c}) (4)

based on the set of supporting points and the variational probability distribution q(Û) of the above assumption, a variational joint distribution of the Aggregation Gaussian

Process is expressed as follows:

q(Ĥ, Û|X,Z)=p(Ĥ|X, Û, Z)q(Û) (5)

where Z is composed of a set of supporting points at C moments, and is assumed to belong to the same distribution as the input at each time; a support variable in the above equation is calculated by a Bayesian equation, and the variational distribution of the Aggregation Gaussian Process after the support variable is marginalized is obtained, q(Ĥ|H, Z) can be obtained by equation (5).

2. Temporal Convolutional Gaussian Process and Variational Form Thereof

After obtaining the spatial dependency Ĥ contained in the topological graph, in order to solve the problem of obtaining temporal features in traffic scenarios, the Temporal Convolutional Gaussian Process shown in FIG. 3 is used to obtain the temporal features after the fusing the space.

S2. The steps of realizing the Temporal Convolutional Gaussian Process are as follows:

S21. Because each vertex may have different temporal features in a period of time, the temporal features including spatial features on the ith vertex are acquired in the following way, namely

hᵢ=Σ_{c=1}^{c}w_{c}g (ĥᵢ^{c}) (6)

where the vertex information ĥᵢ of the graph at each moment is subjected to convolution operation first, and then the spatiotemporal feature hᵢ at the i^{th} vertex can be obtained from the connection at different moments.

S22. By operating the mapping function f(⋅), let the convolution operation method g(⋅) obey the Gaussian process with a mean function of m_{c}: R^{\hat{F}}→R^{F′} and a covariance function of K_{C}: R^{\hat{F}×\hat{F}}→R^{F′}, that is, g(ĥ^{c})˜ [symbol] (m_{C}(ĥ^{c}), K_{C}(ĥ^{c}, ĥ^{c′})) abbreviated as [symbol] (m_{c}, K_{C}); the following Temporal Convolutional Gaussian Process with a weighted convolution kernel function can be obtained from equation (6),

hᵢ|ĥᵢ, w˜ [symbol] (Σ_{c=1}^{C}w_{c}m_{C}, Σ_{c=1}^{C}Σ_{c′=1}^{C}w_{c}w_{c′}K_{C}) (7);

S23. The representation of the Temporal Convolutional Gaussian Process in the above form is not concise, and the efficiency of temporal convolution operation after coding in a computer is low. Therefore, the weight w_{c} is vectorized so as to obtain w=[w₁, w₂, . . . , w_{C}] ∈ R^{C}; a matrix shape corresponding to ĥᵢ is adjusted to [ĥᵢ¹, ĥᵢ², . . . , ĥᵢ^{C}]^{T} ∈ R^{C×\hat{F}} with the C moments constant and a feature length \hat{F} unchanged at the i^{th} vertex. Based on this, the Temporal Convolutional Gaussian Process described in this section can be simplified into the following form:

hᵢ|ĥᵢ, w˜ [symbol] (wm_{C}, w^{T}K_{C}w) (8)

where K_{C,cc} =K_{C}(ĥᵢ^{c}, ĥᵢ^{c′})represents the similarity between the feature at the c^{th} moment and the feature at the c′^{th} moment; and because of the regional characteristics of traffic scenarios, so the spatiotemporal features between points can be seen as independent from each other; based on this, the spatiotemporal feature H=[ĥ₁, ĥ₂, . . . , ĥ_{N}] ∈ R^{1×N×F′} satisfies the following probability distribution form p(H|Ĥ)=Πᵢ₌₁^{N}p (hᵢ).

Similarly, the variational form of the Temporal Convolutional Gaussian Process is given in this part, so that the variational form of the Deep Graph Gaussian Process can be derived subsequently.

The variational form of the Temporal Convolutional Gaussian Process is realized as follows:

the set of supporting points {\hat{z}_{m′}}_{m′=1}^{M}^{_{g}} with the same distributions as ĥ is introduced, and the set of supporting points is calculated by a convolution operation g(⋅) to obtain a supporting random variable u=[g(\hat{z}₁), g(\hat{z}_{M}_{_{g}})], which is made to obey the multidimensional Gaussian distribution q(u) with a mean of m ∈ R^{M}^{_{g}}^{×F′} and a covariance of S ∈ R^{M}^{_{g}}^{×M}^{_{g}}.

When calculating the variational joint distribution, the calculation of the covariance also needs to be combined with the temporal correlation, that is, K*_{C}=w^{T}K_{C}(ĥ, \hat{z}) and K**_{C}=K_{C}(\hat{z}, \hat{z}); based on this, the variational joint expression of the Temporal Convolutional Gaussian Process is constructed,

q(H, U|Ĥ, \hat{Z})=p(H|Ĥ, U, \hat{Z})q(U) (9)

where q(U)=Πᵢ₌₁^{N} [symbol] (m, S); after marginalizing the supporting variables in the above equation, the variational probability q(H|Ĥ, \hat{Z}) of the Temporal Convolutional Gaussian Process is obtained.

3. Description of the Deep Graph Gaussian Process and its Learning Process Thereof

S3. The steps of realizing the Deep Graph Gaussian Process are as follows:

S31. As shown in FIGS. 1A-1C, a unit for acquiring the spatiotemporal feature H ∈ R^{N×F×C} is obtained by stacking the Aggregation Gaussian Processes that can extract spatial dependency and the Temporal Convolutional Gaussian Processes that can extract temporal features, wherein the input of a first layer in the proposed Deep Graph Gaussian Process model is spatiotemporal data H⁰=X, and the transformation of an adjacency matrix A as an input into the weight matrix has been included in the Aggregation Gaussian Process; secondly, the spatiotemporal feature [symbol] as the input of [symbol] ^{th} layer is subjected to an aggregation operation to extract spatial dependency, and then to a convolutional operation to obtain spatiotemporal features therein; finally, H^{L} is input to a forecasted result obtained in the Gaussian process with a linear kernel function.

S32, Let the mapping function [symbol] (⋅) and temporal convolution function [symbol] (⋅) in each layer obey the Gaussian process respectively. Specifically, the Gaussian process that the mapping function [symbol] (⋅) obeys has a mean function of [symbol] : [symbol] → [symbol] and a covariance function of [symbol] : [symbol] → [symbol] , while the temporal convolution function [symbol] (⋅) obeys the Gaussian process with a mean function of [symbol] : [symbol] → [symbol] and a covariance function [symbol] : [symbol] → [symbol] ; the final output layer o(⋅) obeys the Gaussian process defined with a linear covariance function of Kₒ:R^{F}^{_{L}}^{×F}^{_{L}}→R^{F}^{ₒ} and a mean function of mₒ: R^{F}^{_{L}}→R^{F}^{ₒ}; based on the above probability expression, the joint distribution of the Deep Graph Gaussian Process shown in FIGS. 1A-1C is as follows:

p(y, ŷ, { [symbol] , [symbol] )=Πᵢ₌₁^{N}p(yᵢ|6ŷᵢ)p (ŷ|H^{L}) [symbol] p ( [symbol] , [symbol] )p( [symbol] | [symbol] (10)

where ŷ ∈ R^{N}represents the forecasted result given by the method of Deep Graph Gaussian Processes.

Similarly, support variables [symbol] and [symbol] l are introduced into the Aggregation Gaussian Process and Temporal Convolutional Gaussian Process respectively for each layer, and at the same time, it is assumed that the probability distributions thereof are respectively q( [symbol] )= [symbol] ( [symbol] , [symbol] ) and q( [symbol] )=Πᵢ₌₁^{N} [symbol] ( [symbol] , [symbol] ); using the construction method of the set of supporting points in the Aggregation Gaussian Process, Z^{o} composed of the set of supporting points and supporting variable distribution)q(U^{o})= [symbol] (mₒ, S₀) at an output layer are obtained; based on this, the variational joint form of the Deep Graph Gaussian processes can be as follows:

q(ŷ, U^{o}, { [symbol] , [symbol] , [symbol] , [symbol] )=p(ŷ|H^{L}, U^{o}, Z^{o})q(U^{o})· [symbol] p( [symbol] | [symbol] , [symbol] , [symbol] )q( [symbol] )p( [symbol] | [symbol] , [symbol] , [symbol] )q( [symbol] ) (11).

From the Bayes formula, equation (5) and equation (9), q( [symbol] | [symbol] , [symbol] ), q( [symbol] | [symbol] , [symbol] ) and q (ŷ|H^{L}, Z^{o}) can be obtained.

Based on the above marginalization, the variational form of the Deep graph Gaussian Processes is expressed as follows

q(ŷ, { [symbol] , [symbol] (=q(ŷ|H^{L}, Z^{o})· [symbol] q( [symbol] | [symbol] , [symbol] )q( [symbol] | [symbol] , [symbol] ) (12)

The learning method based on the variational form of the Deep graph Gaussian Processes is as follows.

With the increase of data samples, the process of inferring the parameters in the Deep Graph Gaussian Process method will cost a lot of calculation, so the DSVI algorithm is extended to efficiently infer the Deep Graph Gaussian Process method proposed for the first time in this text.

Firstly, after calculating a marginal probability for the variational distribution of [symbol] and [symbol] in equation (12), the posterior probability of the variational Deep Graph Gaussian Processes can be expressed as follows

$$q ( {\hat{y}}_{i} ) = {\int }_{{H}_{i}^{ℓ} , {\hat{H}}_{i}^{ℓ}} q ( {\hat{y}}_{i} , {\{ {H}_{i}^{ℓ} , {\hat{H}}_{i}^{ℓ} \}}_{ℓ = 1}^{L} ) \qquad ( 13 )$$

where, ŷᵢ is the forecasted result of the traffic flow on the i^{th} vertex with independent spatiotemporal features.

Finally, based on the derivation of the variational form of the Deep Graph Gaussian Processes and the variational posterior form thereof, an empirical minimum lower bound of the Deep Graph Gaussian Processes is as follows

$${ℒ}_{DGGPs} = {q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}_{} [ log ( \frac{p ( y , \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}{q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )} ) ] \qquad ( 14 )$$

In addition, from equation (10), equation (11) and equation (13), equation (14) can be obtained:

[symbol]

_{DGGPs}=Σᵢ₌₁^{N} [symbol] _{q(ŷ}_{ᵢ₎}[p(yᵢ|ŷᵢ)]−KL[q(U^{o})∥p(U^{o}|Z^{o})]− [symbol] (KL[q( [symbol] )∥p( [symbol] | [symbol] )]+KL[q( [symbol] )∥p( [symbol] | [symbol] )]) (15)

Using equation (15), the proposed Deep Graph Gaussian Process can be trained based on the improved DSVI algorithm to maximize the empirical minimum lower bound.

4. Experiments

4.1 Experimental Data Set

To verify that the proposed Deep Graph Gaussian Process method can extract complex spatiotemporal features on a small number of samples and give accurate forecasting and quantitative uncertainty, three real traffic flow data sets, namely HHY, PeMS03 and PeMS07, were collected by Zhejiang Transportation Investment Group and Caltrans Performance Measurement System (PeMS) in California, USA. Details of the three data sets can be found below.

The HHY data set provided by Zhejiang Transportation Investment Group contains the traffic flow data of Shanghai-Hangzhou-Ningbo Expressway from Sep. 1, 2019 to Sep. 15, 2019. In order to deal with the lost traffic flow data in this data set, interpolation is adopted. After processing the lost data, the HHY data set was first processed into a data set containing traffic flow within 5 minutes, then the first 60% of high-speed traffic flow data was used as a training set, and the next 10% of high-speed traffic flow data was used as a verification set, taking the rest of the processed data set as a testing set.

The data set of PeMS03 was collected on the traffic network of California's third district, including 555 monitoring points, covering the whole period from Jan. 1, 2018 to Jan. 31, 2018. Similarly, in order to simulate the situation that only a few samples can be collected, two days' traffic flow was selected as the training set, 10% traffic flow was selected as the verification set when the temporal is continuous, and all the remaining traffic flow data were used as the testing set. This kind of data division can ensure that the sample size of the training data is much lower than that required for normal depth model training.

The data set of PeMS07 included four months of traffic flow data in the 7th district of California, that is, from May 1, 2017 to Aug. 31, 2017. The data set was processed in the same way as the operation on PeMS03. Finally, according to the above traffic flow, the Z-score method was adopted for normalization. At the same time, by using the graph structure description method, the above three data sets could be constructed as the spatiotemporal data of the graph structure.

4.2 Experimental Setting

The Deep Graph Gaussian Process method provided by the present application can be constructed under the Windows 10 operating system and under the hardware conditions equipped with AMD Ryzen7 3700X CPU, 8GB RAM and GeForce GTX 1660 GPU, and the corresponding training and testing can be completed. The Deep Graph Gaussian Process model was written in Python3.6 computer language, constructed by the Gaussian process framework GPflow and the deep learning framework TensorFlow, and an Adam optimizer with a learning rate of 0.0005 was adopted to maximize the empirical minimum lower bound.

Based on the above software and hardware conditions and the built model, the hyperparameters in the proposed method have the following choices. The basic kernel functions in the Depth Graph Gaussian Process, namely, K_{N}(⋅,⋅), K_{C}(⋅,⋅), K_{E}(⋅,⋅), were selected as a radial basis function, a radial basis function and a cosine function as kernel functions, which were used to construct covariance functions in the Aggregation Gaussian Process and Temporal Convolutional Gaussian Process. Because the traffic flow forecasting problem is a regression problem, the Gaussian likelihood in the GPflow framework was selected when selecting the likelihood function in the proposed method. In addition, when the traffic flows at six moments were selected as the input, the input samples could be reduced to simulate the scenario with a small number of samples, while retaining the required historical information. After weighing the risk of over-fitting and under-fitting, the feature length F of the spatiotemporal features in the model was set to 4 and F was set to 8. Meanwhile, on the three data sets of HHY, PeMS03 and PeMS07, the values of [symbol] (1≤ [symbol] ≤L)in various layers of the model were [6,2], [6,2,2] and [6,2,2] respectively. In addition, the proposed Deep Graph Gaussian Process needs to be inferred based on the DSVI algorithm. Therefore, after considering the inference efficiency and the actual situation of the problem, the size of the set of supporting point at the input layer was set to 3 in this section, and the size of the set of supporting point at the remaining layers was set to 16.

In order to comprehensively and accurately evaluate the proposed Deep Graph Gaussian Processes (DGGPs), the Mean Absolute Percentage Error (MAPE), Mean Absolute Error (MAE) and Root Mean Square Error (RMSE) were adopted in the experimental part. Under the above settings, the following comparison methods were selected: Historical Average (HA), Support Vector Regression (SVR), Auto Regression Integrated Moving Average (AMNIA), Gated Recurrent Unit (GRU), Temporal Graph Convolutional Networks (T-GCN), Spatiotemporal Graph Convolutional Networks (STGCN), Graph Wave Networks (GWNet), and Diffusion Convolutional Recurrent Neural Networks (DCRNN).

The above-mentioned Historical Average (HA) method is a benchmark method. The concrete operation of this method is to take the average value of the data at six moments as the forecasted value. Support Vector Regression (SVR) is a model based on temporal processing. The main feature of this model is to construct the relationship between the historical traffic flow and future traffic flow, so as to provide the traffic forecasted value after the historical traffic flow is given. The Auto Regression Integrated Moving Average model is also a temporal model. This model mainly gives the future forecasted results by fitting the historical traffic flow. The Gated Recurrent Unit is an improved temporal deep learning model based on a circular convolutional network structure.

Besides the above-mentioned temporal models, several deep spatiotemporal models are selected. The temporal graph convolutional network is a model based on a variety of neural networks, which includes a graph convolutional network and a Gated Recurrent Unit to predict traffic flow. A spatiotemporal convolutional network is another deep learning model. The model can accurately predict the traffic flow by extracting the spatiotemporal features of the road network. The Graph Wave Network is an improved version of a deep spatiotemporal graph network model with the same name, and its original version was published on the top conference IJCAI-19. Finally, the Diffusion Convolutional Recurrent Neural Network is also a deep network model. This model uses a diffusion convolutional network and a temporal learning framework to extract spatial dependency and temporal features, and then gives the forecasting of the traffic flow.

4.3 Experimental Analysis

Firstly, the ablation experiment was designed for the proposed Deep Graph Gaussian Processes, and it is concluded that different aggregation modes will affect the convergence rate of the trained model, and the forecasted results given by the model at different depth settings are also obviously different.

Secondly, on three real data sets, the proposed deep spatiotemporal model is compared with several classical models and optimal models. In this section, it is verified that the model constructed by the proposed method not only surpasses the optimal model in many evaluation indexes, but also provides a reliable uncertainty measure.

4.3.1 Ablation Experiment

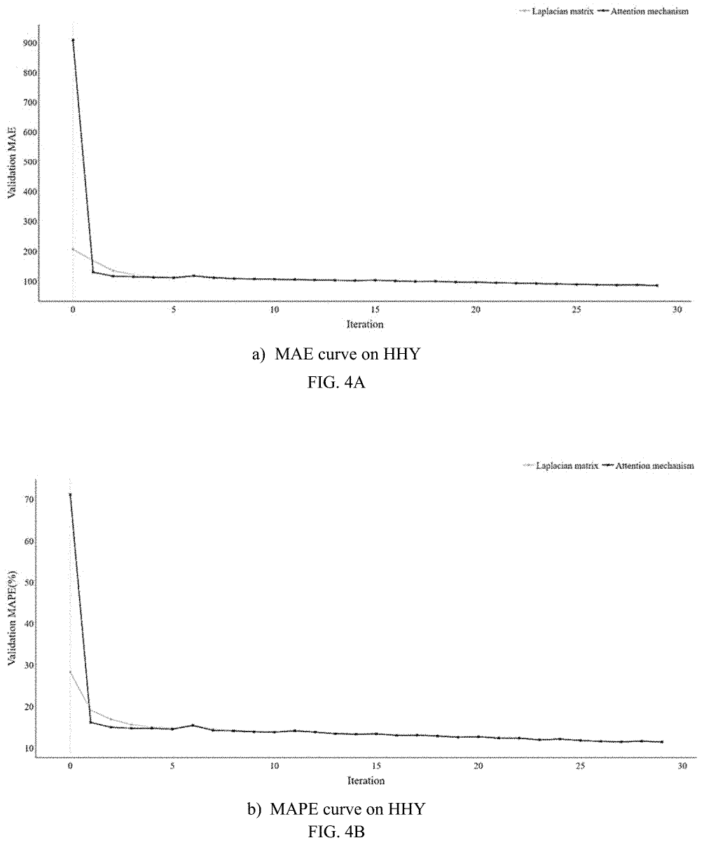

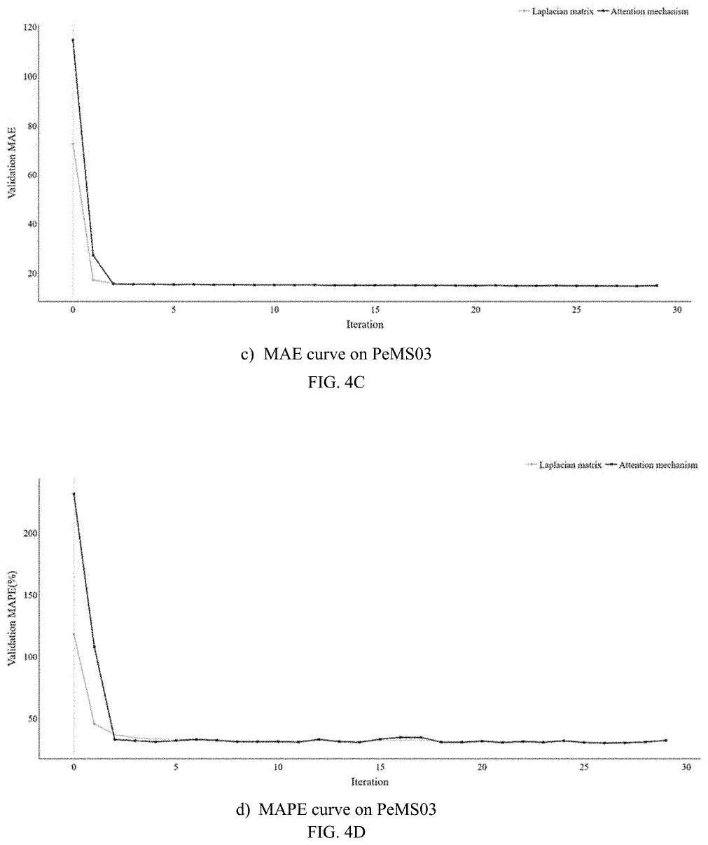

In the ablation experiment part, under the condition that other conditions are controlled to be the same, different aggregation methods, namely Laplacian matrix aggregation and attention mechanism aggregation proposed in the present application, are adopted for the model, and the experimental results shown in FIGS. 4A-4D are obtained. On the HHY data set, compared with Laplacian matrix aggregation, the convergence rate of the model in the aggregation constructed by attention mechanism is obviously faster on the validation set. In addition, on the PeMS03 data set, when the average absolute error is selected as the evaluation index, the advantage of aggregation under attention mechanism is not obvious. However, when the average percentage error is selected, the aggregation method under the attention mechanism is slightly better. One explanation of the experimental results is that the Deep Graph Gaussian Process method is influenced by the features of the traffic flow data when it uses attention mechanism to obtain the dynamic spatial correlation on the road network. For example, the PeMS03 data set has strong irregularity. In a word, the aggregation method using the attention mechanism not only extracts the dynamic spatial dependency, but also helps to reduce the training time. However, the design of the aggregation method still has great research value.

TABLE 1
Evaluation results at different depths L

| Metrics | L = 1 | L = 2 | L = 3 |
|---|---|---|---|
| MAPE (%) | 29.60 | 28.55 | 28.14 |
| MAE | 17.03 | 16.60 | 16.04 |
| RMSE | 27.17 | 26.51 | 25.83 |

TABLE 2
Time taken for training at different depths L

| L = 1 | L = 2 | L = 3 |
|---|---|---|
| 49103.21 s | 62278.38 s | 76533.55 s |

In the ablation experiment, not only the Deep Graph Gaussian Process methods under different aggregation modes are compared, but also the performance of models under different depths is compared. The experimental results are shown in Table 1. Obviously, when the Deep Graph Gaussian Process has a three-layer structure, it can get the best forecasted result on THE PeMS03 data set. The experimental results once again confirm that stacking multi-layer Gaussian processes is beneficial to obtain the most representative data features in the data. However, as shown in Table 2, under the same experimental conditions mentioned above, the time required for model training will increase with the increase of the model depth. Therefore, when using the proposed model, it is necessary to weigh the influence between training time and forecasting accuracy.

4.3.2 Comparative Experiment

After the ablation experiment, three real data sets were used to verify and test the proposed Deep Graph Gaussian Process method. On the three data sets used, all models used a small number of samples as training sets, and the forecasted results were given on the test sets to verify that the proposed method could accurately predict traffic flow with the help of the extracted complex spatiotemporal features with only a small number of samples. The performance of the proposed model will be introduced based on the HEY data set, PeMS03 data set and PeMS07 data set respectively.

TABLE 3
Evaluation results on HHY

| Metrics | DGGPs | HA | SVR | ARIMA | GRU | T-GCN | STGCN | GWNet | DCRNN |
|---|---|---|---|---|---|---|---|---|---|
| MAPE(%) | 3.82 | 13.99 | 4.26 | 7.26 | 10.03 | 10.57 | 5.63 | 4.21 | 3.82 |
| MAE | 27.99 | 101.42 | 29.73 | 52.24 | 98.83 | 73.12 | 34.15 | 35.39 | 28.36 |
| RMSE | 77.87 | 153.77 | 88.37 | 107.93 | 129.10 | 124.42 | 79.65 | 99.80 | 80.79 |

Firstly, on the HEY data set, the Deep Graph Gaussian Process proposed by the present application is compared with the selected comparison method, and the results shown in Table 3 are obtained. Compared with other comparison methods, the Deep graph Gaussian Process has reached the lowest level in all evaluation indexes, which further shows that the deep spatiotemporal model constructed in this chapter can obtain data features from a small number of samples and give accurate traffic flow forecast. From the experimental results, it can be seen that classical temporal models, such as SVR and ARIMA, can achieve better forecasted results with a small number of training samples. Compared with the traditional deep learning model GRU, the deep learning models such as STGCN, GWNet and DCRNN, which can extract spatiotemporal features, can give more accurate traffic flow forecasted results. However, T-GCN, a deep learning model, cannot get effective features from a few samples to predict traffic flow.

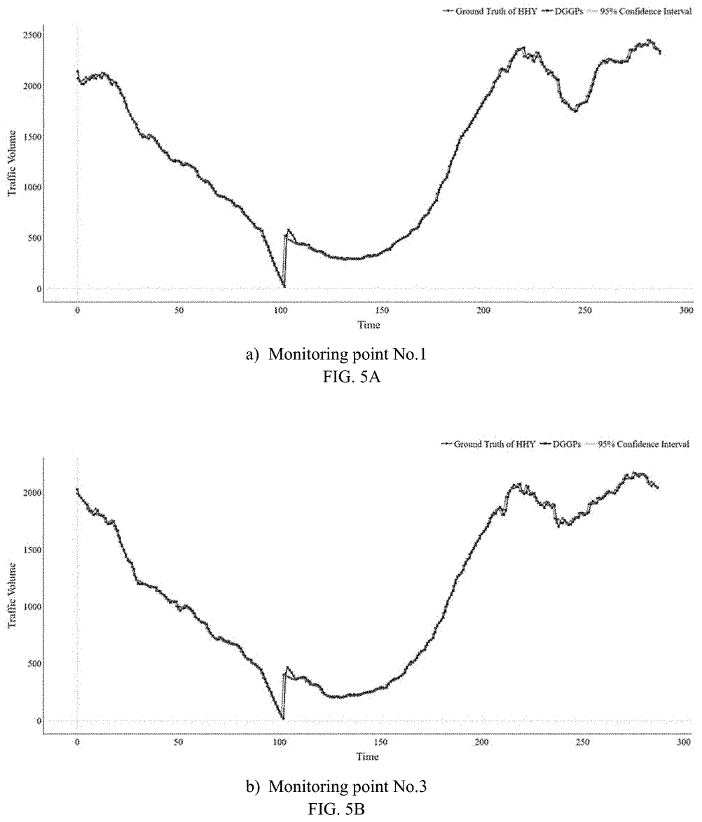

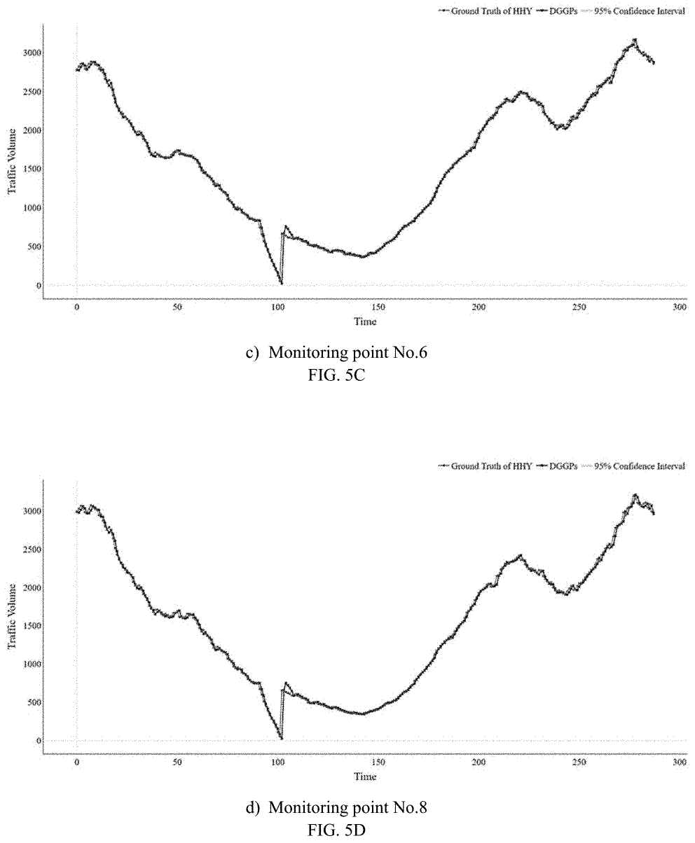

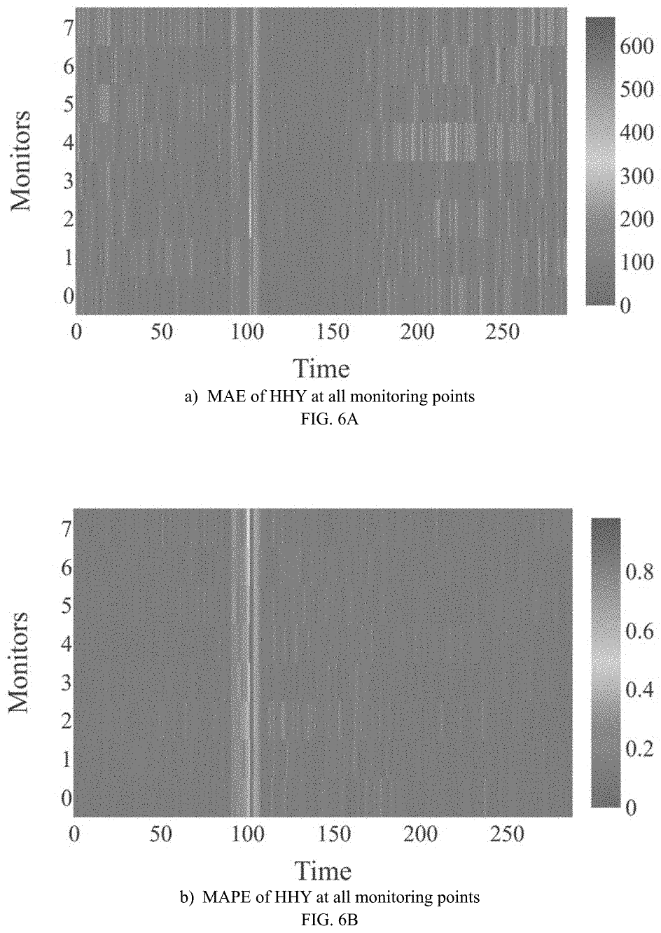

In addition, in order to know more intuitively the forecasted results of the proposed model and the quantification degree of spatiotemporal uncertainty, a No. 1 monitoring point, a No. 3 monitoring point, a No. 6 monitoring point and a No. 8 monitoring point were randomly selected on the upper and lower lanes, and the forecasted value curve, the 95% confidence interval about the forecasted value and the real traffic flow curve were drawn on FIGS. 5A-5D. Because the missing values are processed by interpolation, there is an unnatural V-shaped curve in FIGS. 5A-5D. As can be seen from FIGS. 5A-5D, except for the V-shaped part, the forecasted results given by the proposed Deep Graph Gaussian Process method are almost consistent with the real traffic flow. Similarly, in order to more intuitively understand the deviation between the forecasted result of Deep Graph Gaussian Processes and the real traffic flow, the average absolute error and average percentage error calculated at all monitoring points in this chapter were plotted as the heat map shown in FIGS. 6A-6B. Similarly, except for the V-shaped part obtained by interpolation, FIGS. 6A-6B once again proves that the Deep Graph Gaussian Process method can predict almost real traffic flow by extracting complex spatiotemporal features from a small number of samples.

The reason why the Deep Graph Gaussian Process method provided by the present application can obtain the above accurate forecasted results after training a small number of samples is that the model compiled by this method is similar to the Gaussian process, that is, it has good generalization under a small number of samples. At the same time, the Deep Graph Gaussian Process model also obtains the most representative data features from a small number of samples through a depth structure, so it has more accurate forecasting than the classical model and the current optimal model. The experimental results not only have a deeper understanding of the proposed method, but also have a new understanding of the traditional method and another deep spatiotemporal model. For example, SVR and ARIMA models cannot predict traffic flow at multiple monitoring points at the same time; the training period of the T-GCN model is extremely long, while the HA method is too simple. Based on this, in the experimental part with more monitoring points, the above model will be removed from the comparison model.

TABLE 4
Evaluation results on PeMS03

| Metrics | DGGPs | GRU | STGCN | GWNet | DCRNN |
|---|---|---|---|---|---|
| MAPE (%) | 28.82 | 84.37 | 31.41 | 76.25 | 48.25 |
| MAE | 15.81 | 23.61 | 16.29 | 45.45 | 28.86 |
| RMSE | 25.57 | 40.54 | 25.83 | 61.41 | 42.33 |

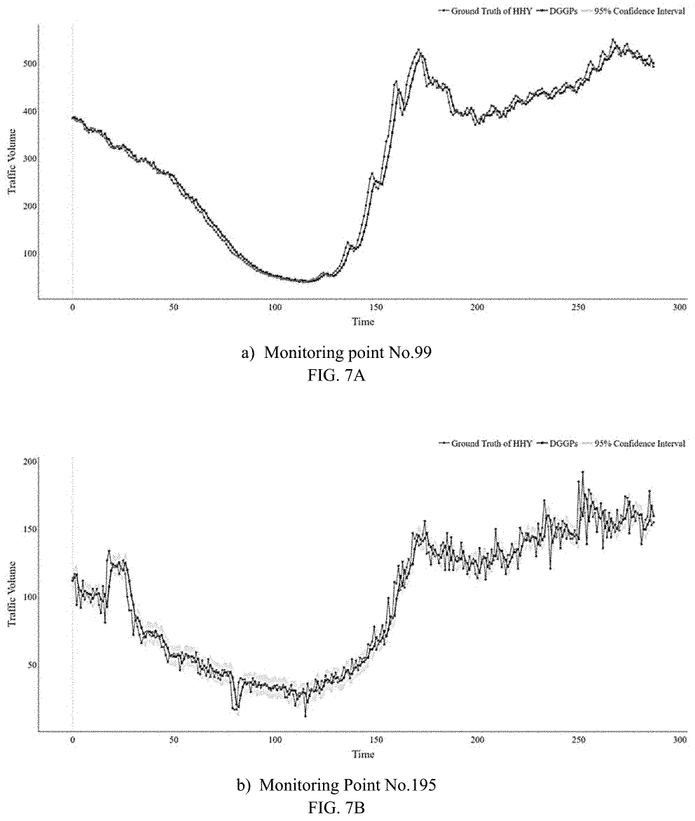

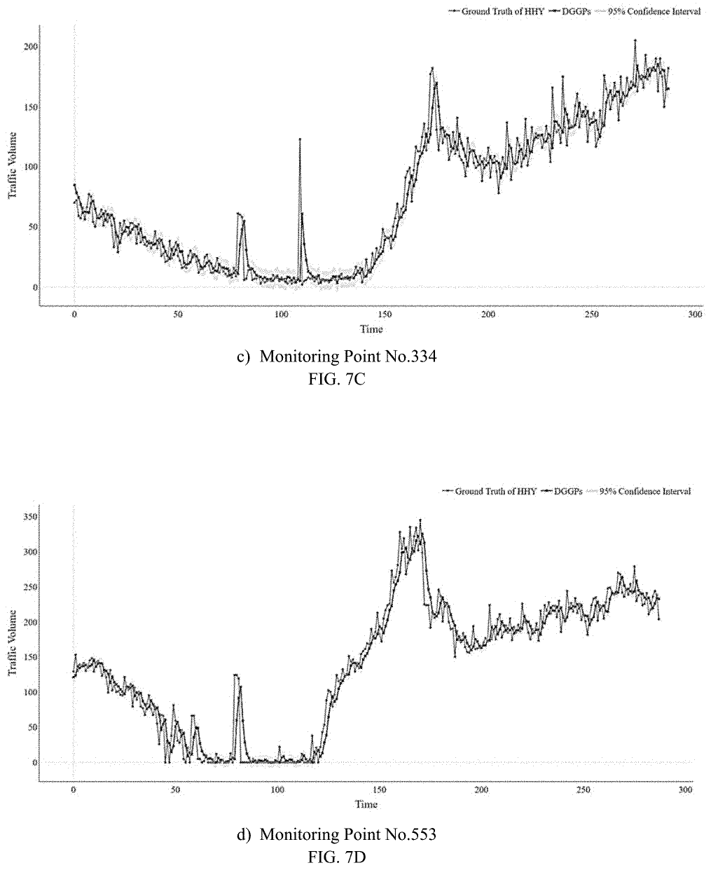

Secondly, the experimental results on PeMS03 data set are shown in Table 4. Compared with the existing optimal depth learning model, the proposed Deep Graph Gaussian Processes can obtain complex spatiotemporal features from a small number of samples by virtue of the advantages of a Gaussian process and a depth structure, and can accurately predict traffic flow. In addition, compared with the HHY data set, there is a big error between the forecasted result of the comparison model and the real flow of the data set, one of the reasons is that the number of trained data samples drops sharply. Especially, the Deep graph Gaussian Process has absolute advantages over the GWNet model. In addition, as can be seen from FIGS. 7A-7D, the traffic flow on the PeMS03 data set is uncertain, so the traffic flow shows obvious temporal fluctuations. Therefore, the GWNet model is sensitive to data. In addition, from the point the of average percentage error, the GRU model, which can only extract time features, does not deal with the special situation of vehicle traffic, that is, when the traffic flow is small or even zero.

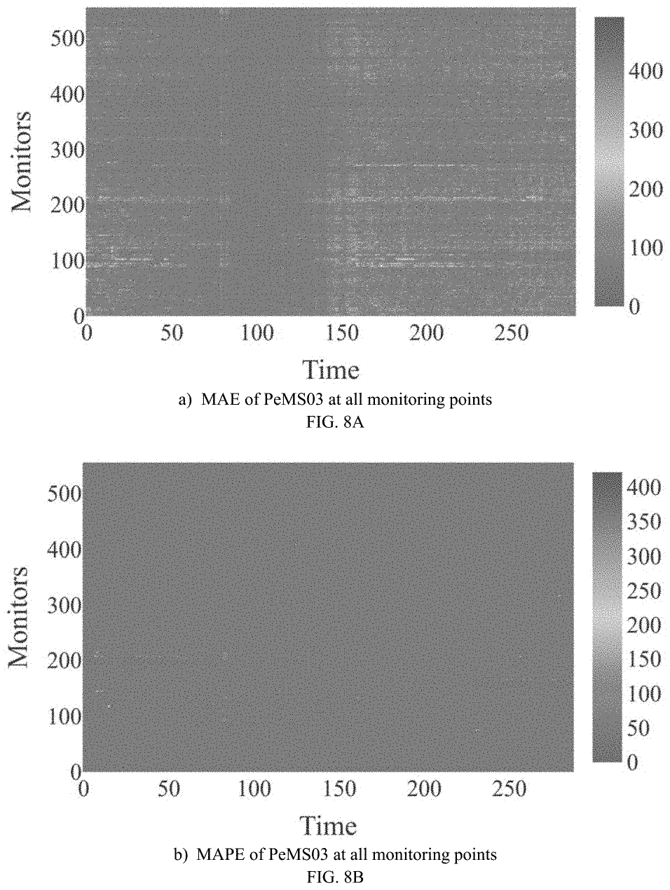

Similarly, four monitoring points were randomly selected from this data set, and the real traffic flow curve, forecasting curve and its confidence interval within 24 hours were drawn. As shown in FIGS. 7A-7D, the proposed Deep Graph Gaussian Processes not only gives accurate traffic flow forecast, but also uses the confidence interval to provide temporal uncertainty measurement. When the traffic flow in time sequence fluctuates irregularly, the given confidence interval can effectively quantify the uncertainty. At the same time, even in the special case of no vehicles passing by, the proposed Deep Graph Gaussian Process still gives reliable forecasted results. As shown in FIGS. 8A-8B, the average absolute error and the average percentage error calculated at all monitoring points are displayed visually. Combined with FIGS. 7A-7D, sub-graph a) in FIGS. 8A-8B shows that the Deep graph Gaussian Process has good overall performance, except at a few monitoring points and in the period with a large traffic flow fluctuation. Besides, the sub-graph b) in FIGS. 8A-B shows that the Deep Graph Gaussian Process can give an accurate forecasted result, even if the traffic flow is zero.

TABLE 5
Evaluation results on PeMS07

| Metrics | DGGPs | GRU | STGCN | GWNet | DCRNN |
|---|---|---|---|---|---|
| MAPE (%) | 9.70 | 68.27 | 14.41 | 12.88 | 11.21 |
| MAE | 19.75 | 37.53 | 20.76 | 19.76 | 20.67 |
| RMSE | 30.47 | 62.66 | 31.26 | 30.47 | 31.14 |

Finally, on the PeMS07 data set, the comparison results of the Deep graph Gaussian Process and related comparison models are shown in Table 5. On the basis of this relatively stable data set, although the forecasted results finally given by various methods are close to the real traffic flow, the Deep Graph Gaussian Process method provided by the present application still has advantages. Moreover, compared with the general deep spatiotemporal model, the proposed method uses the Aggregation Gaussian Process and the Temporal Convolutional Gaussian Process to obtain complex features, thus providing the accurate traffic flow forecasted results only with a small number of samples. For this reason, the proposed Deep Graph Gaussian Process method performs best in the index of average percentage error. Furthermore, because there are still temporal fluctuations in the PeMS07 data set, the performances of the GWNet and DCRNN models in all indicators are not satisfactory. Obviously, GRU is the worst of all models, because this model is not good at predicting traffic flow values in multiple locations at the same time.

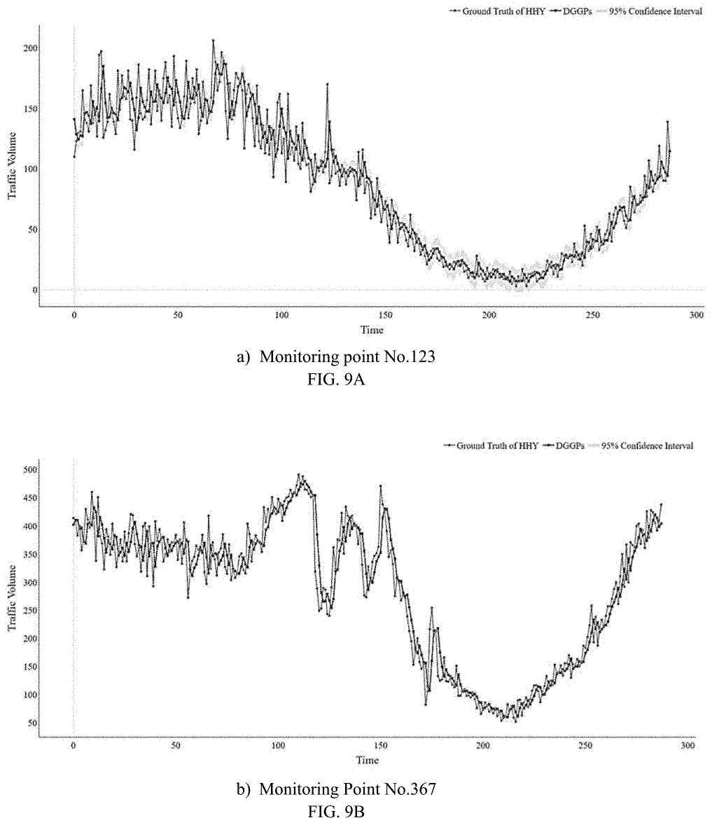

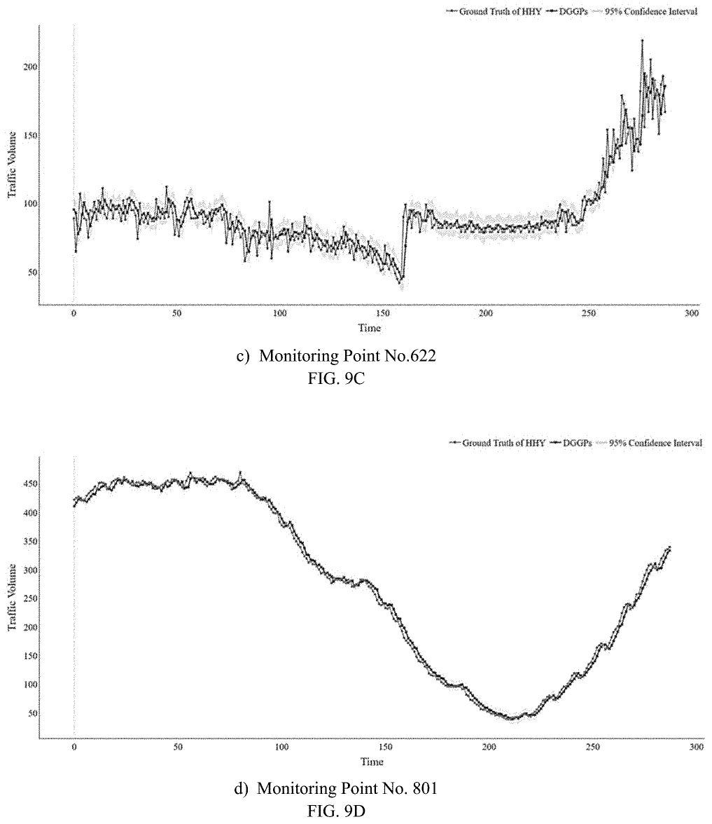

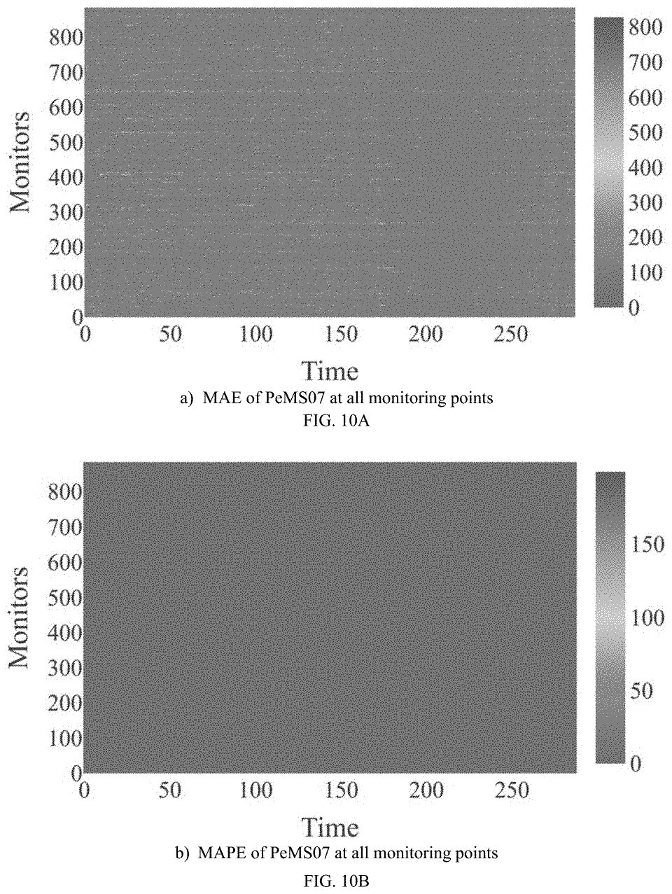

As can be seen from FIGS. 9A-9D, the proposed Deep Graph Gaussian Processes can accurately predict the future traffic flow, and the given confidence interval can also provide an uncertainty measure for traffic flow, thus reducing the uncertainty in time sequence. In addition, FIGS. 10A-10B also shows the evaluation results of all monitoring points. Whether in mean absolute error or mean percentage error, the proposed method has little error over almost all time periods, i. e., it gives a prediction result close to the real traffic flow. At the same time, the experimental results also show that the Deep Graph Gaussian Process method based on multi-layer Gaussian process can effectively obtain the spatiotemporal features of different monitoring points and give accurate forecasted results based on the extracted features.

Combined with the experimental results shown above, the following conclusions are made at the end of the experiments, including the structure of the Deep Graph Gaussian Process and the performance of the Deep Graph Gaussian Process on different data sets. First of all, from the experimental results, the dynamic spatial features can be obtained by using the attention kernel function of the attention mechanism, thus accelerating the convergence rate of the model during training. At the same time, it is confirmed that the depth structure can improve the forecasting accuracy by obtaining the most representative data features. Secondly, on multiple data sets, the Deep Graph Gaussian Process method proposed in this chapter has obvious advantages in areas with scarce data resources. At the same time, by dividing a small amount of data into training samples in areas with abundant data resources, the forecasted results of the optimal depth model can also be achieved. Finally, the experiment proves that the proposed method can effectively reduce the uncertainty with the help of confidence interval, and can deal with the special situation of no vehicle passing in real traffic. In addition, the proposed method selects appropriate model parameters through a learning algorithm, so as to effectively extract complex spatiotemporal features from a small amount of traffic data, and give accurate traffic flow forecasting and uncertainty quantification.

The above embodiments are intended to explain, rather than to limit the present application, and any simple modification of the present application falls into the protection scope of the present application.

What is claimed is:

1. A traffic flow forecasting method based on deep graph Gaussian processes, comprising the following steps:
S1, with respect to the dynamics existing in a spatial dependency, using an attention kernel function to describe a dynamic dependency among vertices on a topological graph, and using the attention kernel function as a covariance function in an aggregation Gaussian process to extract dynamic spatial features;
S2, obtaining a temporal convolutional Gaussian process from weights at different times and a convolution function obeying Gaussian processes, and obtaining temporal features in traffic data by combining the aggregation Gaussian process;
S3, constructing a deep graph Gaussian process method integrating a Gaussian process and a depth structure from the aggregation Gaussian process, the temporal convolutional Gaussian process and the Gaussian process with a linear kernel function, inputting a data sample to be forecasted into the deep graph Gaussian process method, extracting the spatial dependency by the aggregation Gaussian process in step Si, then obtaining the spatiotemporal features by the convolution function in step S2, and inputting the spatiotemporal features into the Gaussian process with the linear kernel function to obtain a forecasted result.

2. The traffic flow forecasting method based on deep graph Gaussian processes according to claim 1, wherein the step Si specifically comprises the following steps:
S11, using a kernel function K_{E}(⋅,⋅) to describe dynamic correlation in space, and a relation between graph vertices being expressed as:
W=(I+A)K_{E}(x, x′) (1)
where W represents a weight of each edge on the topological graph, K_{E}(x, x′) is used to measure the dynamic correlation between the vertices, and an identity matrix I is used to indicate existence of a self-loop on the topological graph, to express an influence of a vertex feature of a current graph on itself at different times;
S12, based on equation (1), extracting spatial features at a moment by equation (2):
$${\hat{h}}_{i} = \frac{{W}_{ii} f ( {x}_{i} ) + {\sum }_{j ∈ Ne ( i )} {W}_{ij} f ( {x}_{j} )}{{D}_{ii}} \qquad ( 2 )$$
where a diagonal element in a diagonal matrix in equation (2) is Dᵢᵢ=Wᵢᵢ+Σ_{j ∈Ne(i)} Wᵢⱼ, and Ne(i)={j:j ∈ {1, . . . , N}, Aᵢⱼ=1} represent neighboring vertices of an i^{th} vertex on the topological graph at the moment;
S13. based on the Aggregation Gaussian Process shown in the equation (2), letting a vertex mapping function f(⋅) obey the Gaussian process with a mean function of m_{N}: R^{F}→R^{\hat{F}} and a covariance function of K_{N}: R^{F×F}→R^{\hat{F}}, that is, f (x)˜ [symbol] (m_{N}(x), K_{N}(x,x′)), abbreviated as f (x)˜ [symbol] (m_{N}, K_{N}); from the equation (2), the Aggregation Gaussian Process for obtaining the dynamic dependency between vertices can be obtained, that is, the following representation:
ĥ|x˜ [symbol] (Pm_{N}, PK_{N}P^{T}) (3)
where P=D⁻¹W and K_{N,ij}=K_{N}(xᵢ, x₁); accordingly, the spatial features Ĥ=[ĥ¹, ĥ², . . . , ĥ^{C})] ∈ R^{C×N×\hat{F}} at C monents can be expressed as a result after independent sampling at multiple times, and obey the probability distribution p(Ĥ|X)=Π_{c=1}^{c}p(ĥ^{c}).

3. The traffic flow forecasting method based on deep graph Gaussian processes according to claim 2, wherein the covariance function in the Gaussian process selects a positive definite kernel function K_{N}(⋅,⋅), the covariance function is rewritten as an inner product form between feature maps, i.e., K_{N}(xᵢ, xⱼ)=ϕ(xᵢ)ϕ(xⱼ)^{T}, and K_{N}=Φ_{N}Φ_{N}^{T}; the aggregation Gaussian process represented by equation (3) contains an attention kernel function K_{A}=PΦ_{N}Φ_{N}^{T}P^{T}=Φ_{A}Φ_{A}^{T} that describes the structure of dynamic graph, where Φ_{A}=PΦ_{N}; the aggregation Gaussian Process is expressed as ĥ˜ [symbol] (Pm_{N}, K_{A}) by using the attention kernel function.

4. The traffic flow forecasting method based on deep graph Gaussian processes according to claim 3, where in a variational form of the aggregation Gaussian process is realized as follows:
assuming that a set of supporting random variables û=[f(z₁), f(z₂), . . . , f(z_{M}_{_{f}})] obey a multidimensional Gaussian distribution with a mean of \hat{m} ∈ R^{M}^{_{f}}^{×\hat{f}} and a covariance of Ŝ ∈ R^{M}^{_{f}}^{×M}^{_{f}}; wherein, the assumed set of supporting points {zₘ}₌₁^{M}^{_{f}} and an input x of the aggregation Gaussian Process belong to a same data distribution, there is no topological connection between the data points in the set of supporting points, indicating that there is data points in the assumed set of supporting points and data points in an input set; a calculation no connection between data points in the assumed set of supporting points, indicating that there is method for the correlation between the data points in the set of supporting points and the data points in the input set is K*_{N}=PK_{N}(x,z), and a calculation method for the correlation within the set of supporting point is K**_{N}=K_{N}(z, z);
a variational probability distribution at C moments is represented as:
$$q ( \hat{U} ) = {\prod }_{c = 1}^{C} ( {\hat{m}}_{c} , {\hat{S}}_{c} ) \qquad ( 4 )$$
based on the assumed set of supporting points and the variational probability distribution q(Û), a variational joint distribution of the aggregation Gaussian process is expressed as follows:
q(Ĥ, Û|X, Z,)=p(Ĥ|X, Û, Z)q(Û) (5)
where Z is composed of a set of supporting points at the C moments, and is assumed to belong to the same distribution as the input at each time; a support variable in equation (5) is calculated by a Bayesian equation, and a variational distribution of the aggregation Gaussian process after the support variable is marginalized is obtained, q(Ĥ|H, Z) is obtained by the equation (5).

5. The traffic flow forecasting method based on deep graph Gaussian processes according to claim 1, where in the step S2 specifically includes the following steps:
S21, temporal features including spatial features on the i^{th} vertex are acquired by equation (6):
$${h}_{i} = {\sum }_{c = 1}^{C} {w}_{c} ℊ ( {\hat{h}}_{i}^{c} ) \qquad ( 6 )$$
where vertex information ĥᵢ of the graph at each moment is subjected to a convolution operation first, and then the spatiotemporal feature hᵢ at the i^{th} vertex is obtained from a connection at different moments;
S22, by operating the vertex mapping function f(⋅), letting a convolution operation method g(⋅) obey the Gaussian process with a mean function of m_{c}: R^{\hat{F}}→R^{F′} and a covariance function of K_{C}: R^{\hat{F}×\hat{F}}→R^{F′}, to obtain g(ĥ^{c})˜ [symbol] (m_{C}(ĥ^{c}), K_{C}(ĥ^{c}, ĥ^{c′})), abbreviated as [symbol] (m_{c}, K_{C}); a temporal convolutional Gaussian process with a weighted convolution kernel function is obtained from equation (6),
$${h}_{i} \vert {\hat{h}}_{i} , w \sim ( {\sum }_{c = 1}^{C} {w}_{c} {m}_{c} , {\sum }_{c = 1}^{C} {\sum }_{{c}^{′} = 1}^{C} {w}_{c} {w}_{{c}^{′}} {K}_{c} ) ; \qquad ( 7 )$$
S23, vectorizing a weight w_{c} to obtain w=[w₁, w₂, . . . , w_{c}] ∈ R^{c}; a matrix shape corresponding to ĥᵢ is adjusted to [ĥᵢ¹, ĥᵢ ², . . . , ĥᵢ^{c}]^{T} ∈ R^{C×\hat{F}} with the C moments constant and a feature length \hat{F} unchanged at the i^{th} vertex, and the temporal convolutional Gaussian process is simplified as:
hᵢ|ĥᵢ, w˜ [symbol] (wm_{C}, w^{T}K_{C}w) (8)
where K_{C,cc′}=K_{C}(ĥᵢ^{c}, ĥᵢ^{c′})represents the similarity between the feature at the c^{th} moment and the feature at the c′^{th} moment; and the spatiotemporal features
$$H = [ {\hat{h}}_{1} , {\hat{h}}_{2} , … , {\hat{h}}_{N} ] ∈ {R}^{1 \times N \times {F}^{′}}$$
satisfies a probability distribution form p(H|Ĥ)=Πᵢ₌₁^{N}p (hᵢ).

6. The traffic flow forecasting method based on deep graph Gaussian processes according to claim 5, wherein a variational form of the temporal convolutional Gaussian process is realized as follows:
the set of supporting points {\hat{z}_{m′}}_{m′=1}^{M}^{_{g}} with the same distributions as ĥ is introduced, and the set of supporting points is calculated by a convolution operation g(⋅) to obtain a supporting random variable u=[g(\hat{z}₁), g(\hat{z}₂), . . . , g(\hat{z}_{M}_{_{g}})], the supporting random variable is made to obey the multidimensional Gaussian distribution q(u) with a mean of m ∈ R^{M}^{_{g}}^{×F′} and a covariance of S ∈ R^{M}^{_{g}}^{×M}^{_{g}};
when calculating the variational joint distribution, the calculation of the covariance is combined with the temporal correlation, that is, K*_{C}=w^{T}K_{C}(ĥ, \hat{z}) and K**_{C}=K_{C}(\hat{z}, \hat{z}); based on this, the variational joint expression of the temporal convolutional Gaussian process is constructed as follows,
q(H, U|Ĥ, \hat{Z})=p(H|Ĥ, U, \hat{Z})q(U) (9)
where q(U)=Πᵢ₌₁^{N} [symbol] (m, S); after marginalizing the supporting random variables in equation (9), a variational probability q(H|Ĥ, \hat{Z}) of the temporal convolutional Gaussian process is obtained.

7. The traffic flow forecasting method based on deep graph Gaussian processes according to claim 6, where in the step S3 specifically includes the following steps:
S31, obtaining a unit for acquiring the spatiotemporal feature H ∈ R^{N×F×C} by stacking the aggregation Gaussian processes for extracting the spatial dependency and the temporal convolutional Gaussian processes for extracting the temporal features, wherein an input of a first layer in a proposed deep graph Gaussian process model is spatiotemporal data H⁰=X, and a transformation of an adjacency matrix A as an input into a weight matrix is included in the aggregation Gaussian process; subjecting the spatiotemporal feature [symbol] as an input of a [symbol] ^{th} layer to an aggregation operation to extract the spatial dependency, and then to a convolutional operation to obtain spatiotemporal features in the [symbol] ^{th} layer; finally, inputting H^{L} to a forecasted result obtained in the Gaussian process with a linear kernel function;
S32, letting a mapping function [symbol] (⋅) and a temporal convolution function [symbol] (⋅) in each layer obey the Gaussian process respectively, wherein the mapping function [symbol] (⋅) obeys the Gaussian process having a mean function of [symbol] : [symbol] → [symbol] and a covariance function of [symbol] : [symbol] → [symbol] , while the temporal convolution function [symbol] (⋅) obeys the Gaussian process with a mean function of [symbol] : [symbol] → [symbol] and a covariance function [symbol] : [symbol] → [symbol] ; a final output layer o(⋅) obeys the Gaussian process defined with a linear covariance function of Kₒ:R^{F}^{_{L}}^{×F}^{_{L}}→R^{F}^{ₒ} and a mean function of mₒ: R^{F}^{_{L}}→R^{F}^{ₒ}; the variational joint distribution of the deep graph Gaussian process is as follows:
$$p ( y , \hat{y} {\{ {H}^{ℓ} , {\hat{H}}^{ℓ} \}}_{ℓ = 1}^{L} ) = {\prod }_{i = 1}^{N} p ( {y}_{i} \vert {\hat{y}}_{i} ) p ( \hat{y} \vert {H}^{L} ) {\prod }_{ℓ = 1}^{L} p ( {H}^{ℓ} \vert {\hat{H}}^{ℓ} ) p ( {\hat{H}}^{ℓ} \vert {H}^{ℓ - 1} ) \qquad ( 10 )$$
where ŷ ∈ R^{N}represents a forecasted result given by a method of deep graph Gaussian processes.

8. The traffic flow forecasting method based on deep graph Gaussian processes according to claim 7, wherein the variational form of the deep graph Gaussian processes is realized as follows:
support variables [symbol] and [symbol] are introduced into the aggregation Gaussian process and the temporal convolutional Gaussian process respectively for each layer, and it is assumed that probability distributions of the support variables are respectively q( [symbol] )= [symbol] ( [symbol] , [symbol] ) and q( [symbol] )= [symbol] ( [symbol] , [symbol] ); using a construction method of the set of supporting points in the aggregation Gaussian process, Z^{o} composed of the set of supporting point s and a supporting variable distribution q(U^{o})= [symbol] (mₒ, Sₒ) at an output layer are obtained; a variational joint form of the deep graph Gaussian processes is as follows:
q(ŷ, U^{o}, { [symbol] , [symbol] , [symbol] , [symbol] )=p(ŷ|H^{L}, U^{o}, Z^{o})q(U^{o})· [symbol] p( [symbol] | [symbol] , [symbol] , [symbol] )q( [symbol] )p( [symbol] , [symbol] , [symbol] , [symbol] )q( [symbol] ) (11).
according to equation (11), the variational form of the deep graph Gaussian processes is expressed as follows
q(ŷ, { [symbol] , [symbol] (=q(ŷ|H^{L}, Z^{o})· [symbol] q( [symbol] | [symbol] , [symbol] )q( [symbol] | [symbol] , [symbol] ) (12)

9. The traffic flow forecasting method based on deep graph Gaussian processes according to claim 8, wherein a learning method based on the variational form of the deep graph Gaussian processes is as follows:
after calculating a marginal probability for a variational distribution of [symbol] and [symbol] in equation (12), a posterior probability of the variational form of the deep graph Gaussian processes is expressed as follows
$$q ( {\hat{y}}_{i} ) = {\int }_{{H}_{i}^{ℓ} , {\hat{H}}_{i}^{ℓ}} q ( {\hat{y}}_{i} , {\{ {H}_{i}^{ℓ} , {\hat{H}}_{i}^{ℓ} \}}_{ℓ = 1}^{L} ) \qquad ( 13 )$$
where, ŷₜᵢ is a forecasted result of a traffic flow on the i^{th} vertex with independent spatiotemporal features;
based on derivation of the variational form of the deep graph Gaussian processes and a variational posterior form of the deep graph Gaussian processes, an empirical minimum lower bound of the deep graph Gaussian processes is as follows
$${ℒ}_{DGGPs} = {q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}_{} [ log ( \frac{p ( y , \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}{q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )} ) ] \qquad ( 14 )$$
in addition, from equation (10), equation (11) and equation (13), equation (14) is obtained:
$${ℒ}_{DGGPs} = {\sum }_{i = 1}^{N} {q ( {\hat{y}}_{i} )}_{} [ p ( {y}_{i} \vert {\hat{y}}_{i} ) ] - KL [ q ( {U}^{o} ) ‖ p ( {U}^{o} \vert {Z}^{o} ) ] - {\sum }_{ℓ = 1}^{L} ( KL [ q ( {U}^{ℓ} ) ‖ p ( {U}^{ℓ} \vert {\hat{Z}}^{ℓ} ) ] + KL [ q ( {\hat{U}}^{ℓ} ) ‖ p ( {\hat{U}}^{ℓ} \vert {Z}^{ℓ} ) ] ) \qquad ( 15 )$$

10. The traffic flow forecasting method based on deep graph Gaussian processes according to claim 4, where in the step S2 specifically includes the following steps:
S21, temporal features including spatial features on the i^{th} vertex are acquired by equation (6):
$${h}_{i} = {\sum }_{c = 1}^{C} {w}_{c} ℊ ( {\hat{h}}_{i}^{c} ) \qquad ( 6 )$$
where vertex information ĥᵢ of the graph at each moment is subjected to a convolution operation first, and then the spatiotemporal feature hᵢ at the i^{th} vertex is obtained from a connection at different moments;
S22, by operating the vertex mapping function f(⋅), letting a convolution operation method g(⋅) obey the Gaussian process with a mean function of m_{c}: R^{\hat{F}}→R^{F′} and a covariance function of K_{C}: R^{\hat{F}×\hat{F}}, to obtain g(ĥ^{c})˜ [symbol] (m_{C}(ĥ^{c}), K_{C}(ĥ^{c}, ĥ^{c′})), abbreviated as [symbol] (m_{c}, K_{C}); a temporal convolutional Gaussian process with a weighted convolution kernel function is obtained from equation (6),
$${h}_{i} \vert {\hat{h}}_{i} , w \sim ( {\sum }_{c = 1}^{C} {w}_{c} {m}_{C} , {\sum }_{c = 1}^{C} {\sum }_{{c}^{′} = 1}^{C} {w}_{c} {w}_{{c}^{′}} {K}_{C} ) ; \qquad ( 7 )$$
S23, vectorizing a weight w_{c} to obtain w=[w₁, w₂, . . . , w_{C}] ∈ R^{C}; a matrix shape corresponding to ĥᵢ is adjusted to [ĥᵢ¹, ĥᵢ², . . . , ĥᵢ^{C}]^{T} ∈ R^{C×\hat{F}}with the C moments constant and a feature length \hat{F} unchanged at the i^{th} vertex, and the temporal convolutional Gaussian process is simplified as:
hᵢ|ĥᵢ, w˜ [symbol] (wm_{c}, w^{T}K_{C}w) (8)
where K_{C,cc′}=K_{C}(ĥᵢ ^{c}, ĥᵢ ^{c′}) represents a similarity between a feature at a c^{th} moment and a feature at a c′^{th} moment, and the spatiotemporal feature H=[ĥ₁, ĥ₂, . . . , ĥ_{N}] ∈ R^{1×N×F′} satisfies a probability distribution form p (H|Ĥ)=Πᵢ₌₁^{N}p(hᵢ).

11. The traffic flow forecasting method based on deep graph Gaussian processes according to claim 10, wherein a variational form of the temporal convolutional Gaussian process is realized as follows:
the set of supporting points {\hat{z}_{m′}}_{m′=1}^{M}^{_{g}} with the same distributions as ĥ is introduced, and the set of supporting points is calculated by a convolution operation g(⋅) to obtain a supporting random variable u=[g(\hat{z}₁), g(\hat{z}₂), . . . , g(\hat{z}_{M}_{_{g}})], the supporting random variable is made to obey a multidimensional Gaussian distribution q(u) with a mean of m ∈ R^{M}^{_{g}}^{×F′} and a covariance of S ∈ R^{M}^{_{g}}^{×M}^{_{g}};
when calculating the variational joint distribution, a calculation of the covariance is combined with a temporal correlation by K*_{C}=w^{T}K_{C}(ĥ, \hat{z}) and K**_{C}=K_{C}(\hat{z}, \hat{z}); based on this, a variational joint expression of the temporal convolutional Gaussian process is constructed as follows,
q(H,U|Ĥ, \hat{Z})=p(H|Ĥ, U, \hat{Z})q(U) (9)
where q(U)=Πᵢ₌₁^{N} [symbol] (m, S); after marginalizing the supporting random variables in equation (9), a variational probability q(H|Ĥ, \hat{Z}) of the temporal convolutional Gaussian process is obtained.

12. The traffic flow forecasting method based on deep graph Gaussian processes according to claim 11, where in the step S3 specifically includes the following steps:
S31, obtaining a unit for acquiring the spatiotemporal feature H ∈ R^{N×F×C} by stacking the aggregation Gaussian processes for extracting the spatial dependency and the temporal convolutional Gaussian processes for extracting the temporal features, wherein an input of a first layer in a proposed deep graph Gaussian process model is spatiotemporal data H⁰=X, and a transformation of an adjacency matrix A as an input into a weight matrix is included in the aggregation Gaussian process; subjecting the spatiotemporal feature [symbol] as an input of a [symbol] ^{th} layer to an aggregation operation to extract the spatial dependency, and then to a convolutional operation to obtain spatiotemporal features in the [symbol] ^{th} layer; finally, inputting H^{L} to a forecasted result obtained in the Gaussian process with a linear kernel function;
S32, letting the mapping function [symbol] (⋅) and temporal convolution function [symbol] (⋅) in each layer obey the Gaussian process respectively, wherein the mapping function [symbol] (⋅) obeys the Gaussian process with a mean function of [symbol] :R^{F}^{_{l−1}}→→ [symbol] and a covariance function of [symbol] : [symbol] → [symbol] , while the temporal convolution function [symbol] (⋅) obeys th Gaussian process with a mean function of [symbol] : [symbol] → [symbol] and a covariance function [symbol] : [symbol] → [symbol] ; the final output layer o(⋅) obeys the Gaussian process defined with a linear covariance function of Kₒ:R^{F}^{_{L}}^{×F}^{_{L}}→R^{F}^{ₒ} and a mean function of mₒ: R^{F}^{_{L}}→R^{F}^{ₒ}; the variational joint distribution of the Deep Graph Gaussian process is of the deep graph Gaussian process is as follows:
$$p ( y , \hat{y} , {\{ {H}^{ℓ} , {\hat{H}}^{ℓ} \}}_{ℓ = 1}^{L} ) = {\prod }_{i = 1}^{N} p ( {y}_{i} \vert {\hat{y}}_{i} ) p ( \hat{y} \vert {H}^{L} ) {\prod }_{ℓ = 1}^{L} p ( {H}^{ℓ} \vert {\hat{H}}^{ℓ} ) p ( {\hat{H}}^{ℓ} \vert {H}^{ℓ - 1} ) \qquad ( 10 )$$
where ŷ ∈ R^{N}represents a forecasted result given by a method of deep graph Gaussian processes.

13. The traffic flow forecasting method based on deep graph Gaussian processes according to claim 12, wherein the variational form of the deep graph Gaussian processes is realized as follows:
support variables [symbol] and [symbol] are introduced into the aggregation Gaussian process and the temporal convolutional Gaussian process respectively for each layer, and it is assumed that probability distributions of the support variables are respectively q( [symbol] )= [symbol] ( [symbol] , [symbol] ) and q( [symbol] )= [symbol] ( [symbol] , [symbol] ); using a construction method of the set of supporting points in the aggregation Gaussian process, Z^{o} composed of the set of supporting point s and a supporting variable distribution q(U^{o})= [symbol] (mₒ, Sₒ) at an output layer are obtained; a variational joint form of the deep graph Gaussian processes is as follows:
q(ŷ, U^{o}, { [symbol] , [symbol] , [symbol] , [symbol] )=p(ŷ|H^{L}, U^{o}, Z^{o})q(U^{o})· [symbol] p( [symbol] | [symbol] , [symbol] , [symbol] , [symbol] )q( [symbol] )p( [symbol] | [symbol] , [symbol] , [symbol] )q( [symbol] ) (11);
according to equation (11), the variational form of the deep graph Gaussian processes is expressed as follows
q(ŷ, { [symbol] , [symbol] )=q(ŷ|H^{L}, Z^{o})· [symbol] q( [symbol] | [symbol] , [symbol] )q( [symbol] , | [symbol] , [symbol] ) (12)

14. The traffic flow forecasting method based on deep graph Gaussian processes according to claim 13, wherein a learning method based on the variational form of the deep graph Gaussian processes is as follows:
after calculating a marginal probability for a variational distribution of [symbol] and [symbol] in equation (12), a posterior probability of the variational form of the deep graph Gaussian processes is expressed as follows
$$q ( {\hat{y}}_{i} ) = {\int }_{{H}_{i}^{ℓ} , {\hat{H}}_{i}^{ℓ}} q ( {\hat{y}}_{i} , {\{ {H}_{i}^{ℓ} , {\hat{H}}_{i}^{ℓ} \}}_{ℓ = 1}^{L} ) \qquad ( 13 )$$
where, ŷᵢ is a forecasted result of a traffic flow on the i^{th} vertex with independent spatiotemporal features;
based on derivation of the variational form of the deep graph Gaussian processes and a variational posterior form of the deep graph Gaussian processes, an empirical minimum lower bound of the deep graph Gaussian processes is as follows
$${ℒ}_{DGGPs} = {q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}_{} [ log ( \frac{p ( y , \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )}{q ( \hat{y} , {U}^{o} , {\{ {H}^{ℓ} , {\hat{H}}^{ℓ} , {U}^{ℓ} , {\hat{U}}^{ℓ} \}}_{ℓ = 1}^{L} )} ) ] \qquad ( 14 )$$
in addition, from equation (10), equation (11) and equation (13), equation (14) is obtained:
$${ℒ}_{DGGPs} = {\sum }_{i = 1}^{N} {q ( {\hat{y}}_{i} )}_{} [ p ( {y}_{i} \vert {\hat{y}}_{i} ) ] - KL [ q ( {U}^{o} ) ‖ p ( {U}^{o} \vert {Z}^{o} ) ] - {\sum }_{ℓ = 1}^{L} ( KL [ q ( {U}^{ℓ} ) ‖ p ( {U}^{ℓ} \vert {\hat{Z}}^{ℓ} ) ] + KL [ q ( {\hat{U}}^{ℓ} ) ‖ p ( {\hat{U}}^{ℓ} \vert {Z}^{ℓ} ) ] ) \qquad ( 15 )$$
